(19) United States
(12) Patent Application Publication
(10) Pub. No.: US 2006/0189319 A1
(43) Pub. Date: Aug. 24, 2006

(54) Control of a conditional access mechanism

(76) Inventors: Richard J. Houldsworth, Redhill (GB); Immo Benjes, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/548,850

(22) PCT Filed: Feb. 27, 2004
(86) PCT No.: PCT/IB04/00756

§ 371 Date: Sep. 9, 2005

(30) Foreign Application Priority Data
Mar. 15, 2003 (GB) 0305977.1

(51) Int. Cl. H04Q 7/20

(52) U.S. Cl. 455/445

(57) ABSTRACT

A method for enabling access to information services such as subscription television, by subscribers. Information services such as television or radio transmissions are provided to a receiver device over a first communication channel such as a satellite, terrestrial or cable broadcast network. Communication between the receiver device and one or more mobile communication devices is established using a local, short range, transient wireless network defining a second communication channel. The receiver device accesses control data stored on said one or more mobile communication devices within the local wireless network, the access control data enabling access to one or more information services received over the first communication channel.

The present invention relates generally to methods and apparatus for providing a control mechanism for enabling access to data broadcasts, by a media receiver device, for example, access to digital television services by a set top box (STB) or integrated digital television (IDTV).

Conditional access is the control over access to information services provided over a broadcast network. A typical example is a digital television network where individual subscribers have a set of entitlements to receive specific broadcast media channels provided in the broadcast network. The media is typically encrypted when broadcast and a suitable media receiver device is provided with keys to decrypt the required data. Conventionally, the media-receiving device (eg. STB or IDTV) has a decryption unit and individual subscribers are provided with the necessary decryption keys using some suitable mechanism. Known mechanisms include: use of a smart card that must be installed into a card reader in the STB; delivery by fixed telephone line, or by use of the broadcast network itself.

U.S. Pat. No. 6,172,673 B1 describes a multimedia terminal and method for realising multimedia reception in which the keys required for decrypting encrypted transmissions may be delivered to a user by way of a bi-directional communication system such as a mobile telephone network. The user's mobile telephone delivers the decryption keys to the multimedia receiver using a suitable local communication link such as a wired, infra-red or low power radio link.

WO 02/21835 A1 describes a system in which a service terminator unit (such as a STB) receives unidirectional broadcasts from a service source (eg. digital multimedia broadcaster) and a mobile telephone communication network is used to serve as a feedback path between the user and the service source for purposes such as user authentication. The mobile telephone may communicate with the service terminator unit using a wireless method according to the Bluetooth or IEEE 802.11b standards.

In general, the prior art has recognised the usefulness of using a relatively low bandwidth, bi-directional communication network (such as a mobile telephone network) in conjunction with a unidirectional relatively high bandwidth broadcast network to provide data transport between the subscriber and the broadcaster for data streams for which data transport cannot be effected by the unidirectional broadcast network.

It is an object of the present invention to provide enhanced functionality to the broadcast network service conditional access mechanisms described above.

According to one aspect, the present invention provides a method for enabling access to information services by subscribers, comprising the steps of:

delivering an information service over a first communication channel to a receiver device;

establishing communication between the receiver device and one or more mobile communication devices within a local, short range, transient wireless network using a second communication channel; and

retrieving, by the receiver device, access control data stored on said one or more mobile communication devices within the local wireless network, the access control data enabling access to one or more information services received over the first communication channel.

According to another aspect, the present invention provides a service access control device comprising:

a receiver for receiving information services from a service provider over a first communication channel;

a transmitter/receiver unit for communicating with mobile communication devices within a local, short range, transient wireless network using a second communication channel; and

means for retrieving access control data stored on one or more mobile communication devices within the local wireless network, and for using the access control data to enable access to the information services received over the first communication channel.

According to another aspect, the present invention provides a method of operating a mobile telephone to enable access to information services delivered over a first communication channel to a receiver device, comprising the steps of:

storing access control data on the mobile telephone, the access control data enabling access to one or more information services received by the receiver device over the first communication channel;

establishing communication between the receiver device and the mobile telephone over a local, short range, transient wireless network using a second communication channel; and

sending the access control data to the receiver device via the local wireless network to enable access to said one or more information services.

Embodiments of the present invention will now be described by way of example and with reference to the accompanying drawings in which:

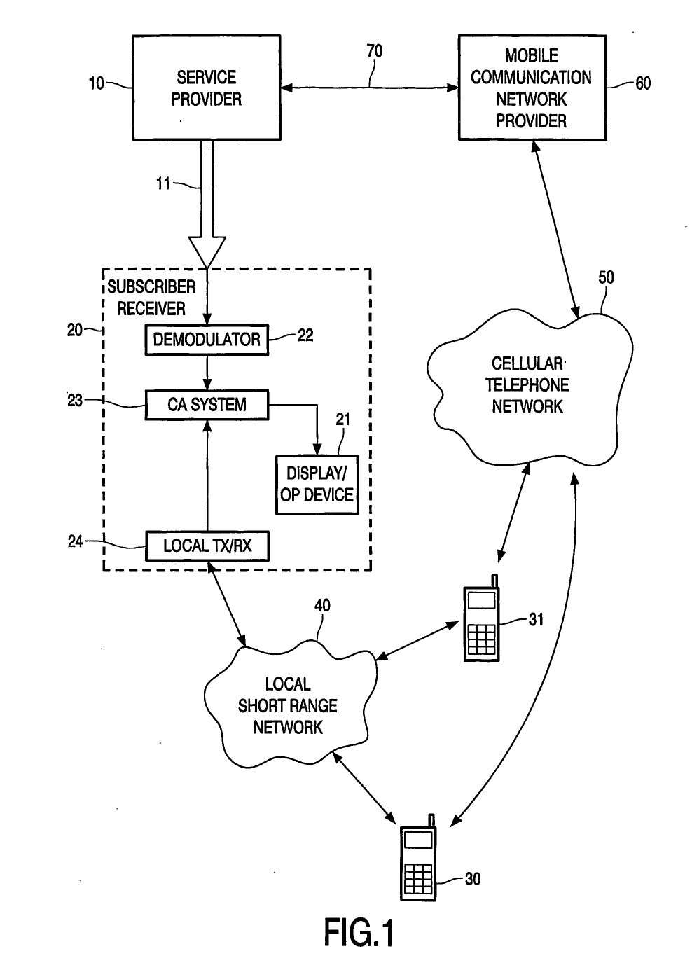

FIG. 1 shows a schematic diagram of a broadcast media system with conditional access control mechanism according to one embodiment of the present invention; and

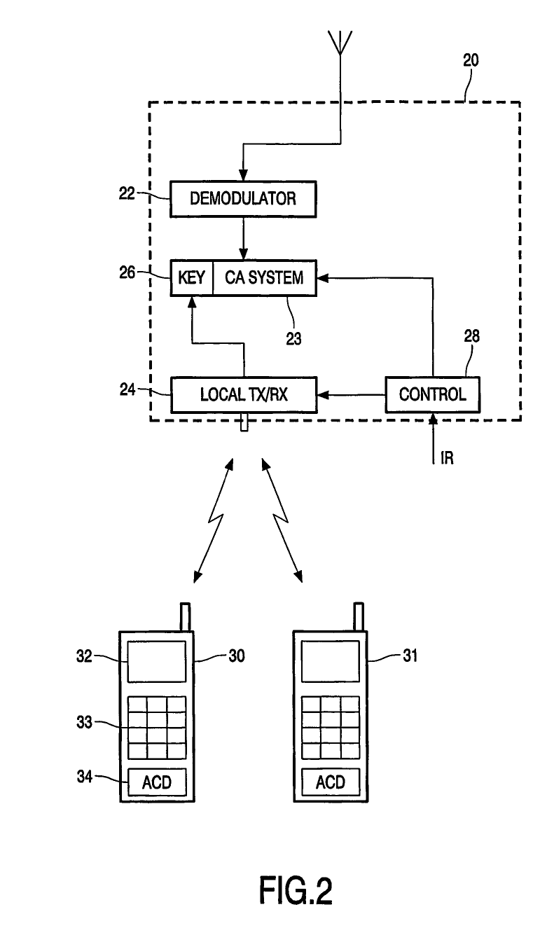

FIG. 2 shows a more detailed diagram of a part of the conditional access control mechanism of FIG. 1.

With reference to FIG. 1 a service provider 10 provides information services over a first communication channel 11 to a number of subscribers, of which one is indicated at 20. The information services may include, for example, television broadcasts, radio broadcasts, multimedia data streams, database information services, internet services.

The first communication channel 11 may be any suitable medium for conveying information in digital or analogue form. The first communication channel 11 is preferably a high bandwidth unidirectional broadcast channel using for example radio, microwave, fibre optic or co-axial cable link. However, other forms of communication may be envisaged, including low bandwidth and/or bi-directional communication channels. The first communication channel 11 may use any suitable known data transmission standard for distribution of digital data including simple continuous data streams, for example the DVB (digital video broadcasting) standard.

In the illustrated embodiment, the information services are provided to a subscriber receiver device 20 which may take the form of a satellite receiver, terrestrial television receiver, set top box (STB), DAB (digital audio broadcast) receiver, a computer or a modem. In a preferred arrangement, the receiver device may be a multimedia home platform (MHP) system.

The subscriber receiver 20 may incorporate or form part of a suitable display 21, for example, an IDTV (integrated digital television) or a suitable record/playback device, such as a DVD or hard disk drive recorder. Alternatively, the subscriber receiver device may be a stand-alone unit for connection to a suitable display device such as a conventional television set or computer monitor.

In the illustrated embodiment, the subscriber receiver device 20 includes a demodulator 22 for extracting digital information signals from the signal broadcast on the first communication channel 11 according to known principles. Conventionally, such digital information signals are encrypted so that access thereto can be controlled by the service provider 10. A conditional access system 23 is provided with a suitable decryption key or set of decryption keys to enable the decryption of such information signals that the individual subscriber is entitled to receive.

More generally, the conditional access system 23 provides a conditional access mechanism which only enables output of useable information service signals (via a demultiplexer and decoder, not shown) to a display 21 or other media output device when predetermined access codes, subscriber identification codes or decryption keys have been provided thereto.

In the present specification, we refer to such codes or keys generally as ‘access control data’, which expression is intended to include any data signal which can be used by the conditional access system to determine whether or not to allow as output to the subscriber useable information service signals, such as a selected television or radio station. It will be understood that the access control data may comprise the decryption key or keys necessary for the conditional access system to decrypt a broadcast signal, or may comprise a password or proof of user identity which permits the conditional access system to decrypt a broadcast signal using keys already stored within the device. If necessary, for enhanced security, the access control data may comprise a partial decryption key that works in conjunction with another partial key provided within the receiver device 20.

In many conventional systems, the decryption keys are provided by way of a smart card issued to the subscriber, which smart card contains the necessary access control data. To use the subscriber receiver device, the user must insert the smart card into the receiver device in order to gain access to the required information services.

Such receivers are generally shared resources, eg. shared within a home by all occupants or members of the same family. Furthermore, they are not generally portable devices and thus cannot be readily carried from house to house for use by the subscriber.

In the present invention, it has been recognised that the mobile telephone is rapidly becoming one of the most personalised devices. They are rarely shared, with most members of a family possessing their own mobile telephone. Furthermore, most users of mobile telephones tend to carry them more-or-less everywhere, and the network protocols established by the cell phone service providers ensure a high degree of certainty of authentication of user.

Further, modern mobile telephones are commonly being provided with short range wireless networking capabilities, using low power radio or infra red communication channels. Typically, such short range wireless capabilities are provided using standards such as Bluetooth or IEEE 802.11. These offer reasonably high bandwidth, ad-hoc transient connections between heterogeneous devices. The Bluetooth protocol stack can be used by applications on a variety of platforms. In particular, use of a Java application program interface (JSR-82) means that many different sorts of Java-enabled devices can access the Bluetooth functionality. These can include both mobile telephones and multimedia receiver devices such as digital television receivers.

Therefore, in the present invention, it is proposed that each user of information services that are generally provided to a receiver device 20 should have, stored on their mobile telephone, suitable access control data for use, preferably by any suitable information service receiver device within the vicinity of the user's mobile telephone.

With further reference to FIG. 1, each user's mobile telephone 30, 31 is adapted to communicate with the receiver device 20 using a local, short range, transient wireless network. This is described herein as the second communication channel 40. The second communication channel 40 may be provided according to the Bluetooth or IEEE 802.11 standards as indicated above. The receiver device 20 includes a transmitter/receiver unit 24 for communication via this second communication channel.

Each mobile telephone 30, 31 is connected to a cellular telephone service provider 60 using a conventional cellular telephone network 50 according to known protocols. As described herein, this forms a third communication channel 50.

A communication link 70 between the information service provider 10 and the cellular telephone service provider 60 enables bi-directional communication between the information service provider 10 and the individual subscriber for information services, identified by their mobile telephone 30 or 31. The information service provider 10 supplies, to each subscriber, suitable access control data to enable access by the holder of a designated mobile telephone to information services delivered via the receiver device 20 (or any other receiver device, if desired). In a preferred arrangement, the access control data is delivered to the mobile telephone using the third communication channel 50.

With reference to FIG. 2, each mobile telephone 30, 31 includes a display 32, user keypad 33 for data entry, and a memory 34 for storing access control data together with any necessary applications program interface, Java or other program for communication with the transmitter/receiver unit 24 of the subscriber receiver device 20.

In a first mode of use, the receiver device 20 acts as a slave device and the mobile telephone 30 acts as a master device. A subscriber brings their mobile telephone within the working range of the local wireless network (second communication channel) transceiver 24 of the subscriber receiver device 20. In order to receive a subscription information service (eg. a pay-TV channel) via the receiver device 20, the user of the telephone then initiates, using keypad 33, a connection with the receiver device 20 over the second communication channel such that both devices form part of the local wireless network. Once the channel is open, the receiver device 20 obtains the access control data from the mobile telephone and passes this data to a key store 26 for use by the conditional access system 23. This enables the conditional access system 23 to provide the desired useable information service signals at output 27.

In an alternative embodiment, the access control data comprises a subscriber identification code or authorisation code unique to the subscriber.

On receiving the code, the receiver device 20 compares this code with a stored list of entitlements for that code to determine which information services may be enabled for delivery of useable information service signals at output 27.

The receiver device 20 may then periodically use the second communication channel to recheck for the continuing presence of the mobile telephone 30 that initiated the transaction. In the event that the receiver 30 device 20 detects removal of the mobile telephone 30 from the local wireless network, the receiver device inhibits further provision of useable information service signals at output 27, for example, by deleting the keys in store 26, or by disabling outputs corresponding to the entitlements for the respective user authorisation code.

The periodic nature of the check for continuing presence may be regular, on a timed basis, or irregular, for example coinciding with the termination of successive program items being output. In the former case, it will be understood that the termination of delivery of the information service may occur whenever the mobile telephone is removed from the vicinity of the receiver device 20, or at a predetermined time after activation. In the latter case, the termination of delivery of information service may occur only when a particular activated delivery is concluded, eg. at the end of a television program being broadcast, regardless of the removal of the mobile telephone during the broadcast.

It will be understood that more than one mobile telephone may be used during any given period to activate delivery of one or more information services, eg. enabling viewing of several different sets of TV channels.

In a second mode of use, the receiver device 20 acts as a master device and the mobile telephone 30 acts as a slave device. A subscriber brings their mobile telephone within the working range of the local wireless network (second communication channel) transceiver 24 of the subscriber receiver device 20. The receiver device 20 periodically or continuously polls the wireless network for all devices thereon. As soon as a new mobile telephone device is detected, a connection is made therewith over the second communication channel. The receiver device 20 obtains access control data from the mobile telephone and passes this data to the key store 26 for use by the conditional access system 23. This enables the conditional access system to provide the desired useable information service signals at output 27 as previously described.

The receiver device 20 periodically or continuously checks the local wireless network for continuing presence of all previously detected mobile telephones. In the event that the receiver device 20 detects removal of a mobile telephone 30 from the local wireless network, the receiver device inhibits further provision of useable information service signals at output 27, corresponding to the entitlements for that mobile telephone (unless another mobile telephone remaining within the network also carries such entitlements).

The termination of delivery of information services corresponding to a removed mobile telephone may occur immediately the mobile telephone is removed from the vicinity of the receiver device 20, at a predetermined time thereafter or when a particular activated delivery is concluded, eg. at the end of a television program being broadcast.

In a third mode of use, the receiver device receives a request from a user for provision of an information service, for example by way of a conventional TV remote control unit (not shown) to a control unit 28. Each time a new service or channel is requested by the user, the receiver device 20 searches the wireless network for a mobile telephone for which the requested service or channel is enabled by the access control data stored thereon. The receiver device 20 obtains the access control data and enables the conditional access system 23 to provide the useable information service signals corresponding to the requested service or channel at output 27.

The existence of the mobile telephone within the local wireless network may therefore be used in place of a smart card plugged into the receiver device 20. It also may be used as guarantee for continuing presence of an authorised user. This can be effective, for example when adult content video material is being broadcast. If the mobile telephone of the adult subscriber is removed from the vicinity of the receiver device 20, then the receiver device will be inhibited from outputting any further program content other than that which is authorised for any mobile telephones remaining in the local wireless network, or which is for general unrestricted output. In this way, certificate rating of broadcast films can be enforced with reference to the user of a mobile telephone within the vicinity of the receiver device.

It will be understood that providing the conditional access mechanism for subscription service by way of access control data stored in mobile telephones results in a system in which individual subscribers can gain access to program content or information services other than at their home location, for example when visiting friends or relatives.

It will also be understood that, because the mobile telephone 30 can communicate with the service provider 10 via the bi-directional (third) communication channel 50, 60, 70, it is possible to deliver pay-per-view decryption keys on a spontaneous basis to the mobile telephone and billing can be performed accordingly. The subscriber identification module (SIM) card of the telephone can be used for user verification.

It is also possible to provide for a fully customised information service that is specific to an individual user, rather than to a household or community using an MHP device.

In a preferred implementation, an application program on the receiver device 20 makes use of the Bluetooth API to discover all devices on the local Bluetooth network (second communication channel 40). Mobile telephones 30, 31 are discoverable as such and identified to the receiver device. The unique identifier of the mobile device can serve as an authentication key. A MIDP application is extracted, for example from a broadcast carousel or from storage in the receiver device 20 and is forwarded to the mobile telephone 30 on the second communication channel 40. The MIDP application starts executing on the mobile telephone 30. It makes use of the Bluetooth API to open a data connection to the receiver device 20 and may also open a connection to the service provider 10 using the third communication channel 50, 70 for delivery of decryption keys or other access control data. This may involve an authentication operation involving both second and third communication channels. The service provider 10 may periodically transmit new keys or other access control data to the mobile telephone 30.

Other embodiments are within the scope of the appended claims.

1. A method for enabling access to information services by subscribers comprising the steps of:
delivering an information service over a first communication channel (11) to a receiver device (20);
establishing communication between the receiver device (20) and one or more mobile communication devices (30, 31) within a local, short range, transient wireless network (40) using a second communication channel; and
retrieving, by the receiver device (20), access control data (34) stored on said one or more mobile communication devices (30, 31) within the local wireless network, the access control data enabling access to one or more information services received over the first communication channel (11).

2. The method of claim 1 further including the steps of:
periodically checking for the existence of new mobile communication devices (30, 31) within the local wireless network (40); and
retrieving access control data (34) stored thereon.

3. The method of claim 1 further including the steps of:
periodically checking for the absence of previously identified mobile communication devices (30, 31) within the local wireless network; and
inhibiting use of access control data previously received therefrom.

4. The method of claim 1 in which the step of establishing communication between the receiver device (20) and any one or more mobile communication devices (30, 31) within the local wireless network (40) is initiated by the receiver device periodically searching for new mobile communication devices.

5. The method of claim 1 in which the step of establishing communication between the receiver device (20) and any one or more mobile communication devices (30) within the local wireless network is initiated by the mobile communication device(s).

6. The method of claim 1 in which the access control data (34) comprises at least one decryption key (26) for decrypting a broadcast information service, and further including the step of:
using said decryption key to decrypt a broadcast information service.

7. The method of claim 6 further including the step of ceasing further decryption when the mobile communication device (30, 31) that provided the decryption key leaves the local wireless network (40).

8. The method of claim 1 in which the access control data (34) comprises a subscriber identification code, and further including the steps of:
checking, by the receiver device (20), the information service entitlements of the subscriber corresponding to the received subscriber identification code; and
enabling access to those information services.

9. The method of claim 8 further including the step of disabling access to those information services when the mobile communication device (30, 31) that provided the subscriber identification code leaves the local wireless network (40).

10. The method of claim 1 further including the steps of:
receiving, by the receiver device (20), a request from a user for provision of one of said information services;
checking, by the receiver device, for the existence of a mobile communication device (30, 31) within the local wireless network that has stored thereon access control data (34) corresponding to the requested service; and
if such a mobile communication device is found within the local wireless network, enabling access to the requested information service; or
if such a mobile communication device is not found within the local wireless network, preventing access to the requested information service.

11. The method of claim 10 further including the step of periodically re-checking, by the receiver device (20), for the continuing existence of a mobile communication device (30, 31) within the local wireless network (40) that has stored thereon access control data (34) corresponding to the requested service; and
if such a mobile communication device is found within the local wireless network, enabling continued access to the requested information service; or
if such a mobile communication device is no longer found within the local wireless network, preventing continued access to the requested information service.

12. The method of claim 1 in which the first communication channel (11) is any of: a satellite broadcast network; a terrestrial TV and/or radio network; a cable TV and/or radio network; a fibre-optic communication path; an internet service network; and a telephone or other cable-based network.

13. A service access control device (20) comprising:
a receiver (20) for receiving information services from a service provider (10) over a first communication channel (11);
a transmitter/receiver unit (24) for communicating with mobile communication devices (30, 31) within a local, short range, transient wireless network (40) using a second communication channel; and
means (23, 24) for retrieving access control data (34) stored on one or more mobile communication devices (30, 31) within the local wireless network, and for using the access control data to enable access to the information services received over the first communication channel (11).

14. The access control device of claim 13 further including means (24) for periodically checking for the existence of new mobile communication devices (30, 31) within the local wireless network (40).

15. The access control device of claim 13 further including means (24) for periodically checking for the absence of previously identified mobile communication devices (30, 31) within the local wireless network (40) and inhibiting use of access control data previously received therefrom.

16. The access control device of claim 13 in which the access control data (34) comprises at least one decryption key (26) for decrypting a broadcast information service, and further including a decryption unit (23) for using said decryption key to decrypt a broadcast information service.

17. The access control device of claim 16 further including means (23, 24) for preventing further decryption when the mobile communication device that provided the decryption key leaves the local wireless network.

18. The access control device of claim 13 in which the access control data (34) comprises a subscriber identification code, and further including:
means (23) for checking the information service entitlements of the subscriber corresponding to the received subscriber identification code; and
means (23) for enabling access to those information services.

19. The access control device of claim 18 further including means (23, 24) for disabling access to those information services when the mobile communication device (30, 31) that provided the subscriber identification code leaves the local wireless network (40).

20. The access control device of claim 1 further including:
means for receiving a request from a user for provision of one of said information services;
means (24) for checking for the existence of a mobile communication device (30, 31) within the local wireless network that has stored thereon access control data corresponding to the requested service; and
means (23) for enabling access to the requested information service if such a mobile communication device is found within the local wireless network, or preventing access to the requested information service if such a mobile communication device is not found within the local wireless network.

21. The access control device of claim 20 further including means (24) for periodically re-checking for the continuing existence of a mobile communication device (30, 31) within the local wireless network that has stored thereon access control data corresponding to the requested service and if such a mobile communication device is found within the local wireless network, enabling continued access to the requested information service, or if such a mobile communication device is no longer found within the local wireless network, preventing continued access to the requested information service.

22. The access control device of claim 13 incorporated within any of: a satellite broadcast receiver; a TV receiver; a set top box (STB), a radio receiver; a computer or a modem.

23. A method of operating a mobile telephone (30, 31) to enable access to information services delivered over a first communication channel (11) to a receiver device (20), comprising the steps of:
storing access control data (34) on the mobile telephone, the access control data enabling access to one or more information services received by the receiver device over the first communication channel;
establishing communication between the receiver device (20) and the mobile telephone (30) over a local, short range, transient wireless network using a second communication channel (40); and
sending the access control data to the receiver device via the local wireless network to enable access to said one or more information services.

24. The method of claim 23 further including the step of receiving said access control data (34) by the mobile telephone (30) over a third communication channel (50, 60, 70), the third communication channel including a cellular telephone network.

25. The method of claim 23 in which the access control data (34) comprises one or more decryption keys.

26. The method of claim 23 in which the access control data (34) comprises a subscriber identification code useable by the receiver to determine a set of subscriber entitlements in respect of the information services received over the first communication channel.

27. The method of claim 23 further including the step of searching for any active receiver devices on the local wireless network prior to sending said access control data thereto.

28. A computer program product, comprising a computer readable medium having thereon computer program code means adapted, when said program is loaded onto a computing device, to make the device execute the procedure of claim 1.

29. A computer program distributable by electronic communication comprising computer program code adapted, when said program is loaded onto a computing device, to make the device execute the procedure of claim 1.
